(19) United States
(12) Patent Application Publication
(10) Pub. No.: US 2026/0316335 A1
(43) Pub. Date: Oct. 15, 2026

(54) PELLET PRODUCTION METHOD, ION EXCHANGE MEMBRANE PRODUCTION METHOD AND PELLETS

(71) Applicant: AGC Inc., Tokyo (JP)

(72) Inventors: Shintaro HAYABE, Tokyo (JP); Kosuke SUMIKURA, Tokyo (JP); Toshiaki SAWADA, Tokyo (JP); Ken KOMATSU, Tokyo (JP)

(73) Assignee: AGC Inc., Tokyo (JP)

(21) Appl. No.: 19/683,210

(22) Filed: May 20, 2026

Related U.S. Application Data
(63) Continuation of application No. PCT/JP2024/040957, filed on Nov. 19, 2024.

(30) Foreign Application Priority Data
Nov. 22, 2023 (JP) 2023-198375

(51) Int. Cl. B29B 9/06; B01D 71/32; B29B 9/10; B29B 9/12; B29K 27/12; B29K 105/00; B29L 31/00

(52) U.S. Cl. CPC B29B 9/06; B29B 9/10; B29B 9/12; B01D 71/32; B29K 2027/12; B29K 2105/251; B29L 2031/755

(57) ABSTRACT

To provide a pellet production method, to produce pellets from which an ion exchange membrane having unevenness of the membrane thickness in the in-plane direction suppressed can be produced by melt-extrusion. A pellet production method, which comprises extruding a melt that contains a fluorinated polymer having groups convertible to ion exchange groups from a die of a melt-extruder to obtain a strand that contains the fluorinated polymer, and cutting the strand to obtain pellets that contain the fluorinated polymer, the method including an air-cooling treatment of cooling the strand extruded from the die by blowing air.

### TECHNICAL FIELD

The present disclosure relates to a pellet production method, an ion exchange membrane production method, and pellets.

### BACKGROUND ART

For batteries, electrolysis processes and ion separation processes, etc., an ion exchange membrane that contains a fluorinated polymer having ion exchange groups has been used.

As a method for producing an ion exchange membrane that contains a fluorinated polymer, a method of using as a material pellets of a fluorinated polymer having ion exchange groups or groups convertible to ion exchange groups has been known.

The pellets are produced, for example, by extruding melt of a polymer from a die, cooling the melt with water into a strand, and cutting the strand by a pelletizer (Patent Document 1).

### PRIOR ART DOCUMENTS

### Patent Documents

Patent Document 1: WO2023/085421

### DISCLOSURE OF INVENTION

### Technical Problem

The present inventors have formed an ion exchange membrane using pellets produced from a water-cooled strand with reference to the technique described in Patent Document 1 and as a result found that the resulting ion exchange membrane may sometimes have uneven membrane thickness in the in-plane direction.

The unevenness of the membrane thickness in the in-plane direction of the ion exchange membrane is required to be small depending upon the application of the produced ion exchange membrane, and reduction of the unevenness of the membrane thickness has been required.

The present disclosure has been made based on the above problem, and according to an embodiment of the present invention, the object is to provide a pellet production method to produce pellets from which an ion exchange membrane with unevenness of the membrane thickness in the in-plane direction suppressed can be produced by melt-extrusion.

According to another embodiment of the present invention, the object is to provide an ion exchange membrane production method, and pellets.

### Solution to Problem

The present disclosure includes the following configurations.
[1] A pellet production method, which comprises extruding a melt that contains a fluorinated polymer having groups convertible to ion exchange groups from a die of a melt-extruder to obtain a strand that contains the fluorinated polymer, and cutting the strand to obtain pellets that contain the fluorinated polymer,
   wherein the method comprises an air-cooling treatment of cooling the strand extruded from the die by blowing air.
[2] The pellet production method according to [1], wherein the groups convertible to ion exchange groups are groups convertible to carboxylic acid functional groups or groups convertible to sulfonic acid functional groups.
[3] The pellet production method according to [1] or [2], wherein in the air-cooling treatment, the air to be blown has a moisture content of 22 g/m³ or less.
[4] The pellet production method according to any one of [1] to [3], wherein the air to be blown has a linear velocity of 5.0 to 50.0 m/sec.
[5] The pellet production method according to any one of [1] to [4], wherein the air to be blown has a temperature of 40° C. or lower.
[6] The pellet production method according to any one of [1] to [5], wherein the fluorinated polymer has an ion exchange capacity of 0.9 meq/g resin or more and 2.00 meq/g resin or less.
[7] The pellet production method according to any one of [1] to [6], wherein the pellets are used for production of an ion exchange membrane.
[8] An ion exchange membrane production method, which comprises:
   producing pellets by the pellet production method as defined in any one of [1] to [7],
   obtaining a precursor membrane using the pellets by melt-extrusion, and
   obtaining an ion exchange membrane using the precursor membrane.
[9] Pellets, which are produced by the method as defined in any one of [1] to [8], and which have a hydrolysis rate of less than 1.00%.

### Advantageous Effects of Invention

According an embodiment of the present invention, provided is a pellet production method to produce pellets with which an ion exchange membrane with unevenness of the membrane thickness in the in-plane direction suppressed can be produced by melt-extrusion method.

According to another embodiment of the present invention, provided are an ion exchange membrane production method, and pellets.

### DESCRIPTION OF EMBODIMENTS

The following definitions of terms apply throughout the present specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may be, for example, (—SO₃⁻)Ma⁺, (—SO₃⁻)₂Mb²⁺ or (—SO₃⁻)₃Mc³⁺ (where Ma⁺ is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may be, for example, (—COO⁻)Ma⁺, (—COO⁻)₂Mb²⁺ or (—COO⁻)₃Mc³⁺ (where Ma⁺ is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “precursor membrane” refers to a membrane that contains a polymer having groups convertible to ion exchange groups.

A “group convertible to an ion exchange group” refers to a group that can be converted to an ion exchange group by known treatments such as hydrolysis and conversion to acid form.

A “group convertible to a sulfonic acid functional group” refers to a group that can be converted to a sulfonic acid functional group by known treatments such as hydrolysis and conversion to acid form.

A “group convertible to a carboxylic acid functional group” refers to a group that can be converted to a carboxylic acid functional group by treatments such as hydrolysis and conversion to acid form.

A “perfluorohydrocarbon group” refers to a hydrocarbon group in which all hydrogen atoms are replaced with fluorine atoms.

A “perfluoroaliphatic hydrocarbon group” refers to an aliphatic hydrocarbon group having all hydrogen atoms being replaced with fluorine atoms.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure. In the following, in some cases, units derived from a certain monomer will be represented by the monomer name, followed by “units”.

A “reinforcing material” refers to a material used to improve the strength of an ion exchange membrane. The reinforcing material is preferably a material derived from a reinforcing cloth.

The “reinforcing cloth” refers to a cloth used as a material of the reinforcing material to improve the strength of an ion exchange membrane.

A numerical range expressed using “to” means a range including numerical values described before and after “to” as the lower and upper limits. When the units of the lower and upper limits are the same, the unit of the lower limit may sometimes be omitted. In a series of numerical ranges described in the present specification, the upper limit or lower limit of a numerical range may be replaced by the upper limit or lower limit of another numerical range in the same series. The upper limit or lower limit of any numerical range described in the present specification may be replaced by any of numerical values indicated in Examples.

### [Pellet Production Method]

The pellet production method of the present disclosure (hereinafter also referred to as the present production method) is a pellet production method, which comprises extruding a melt that contains a fluorinated polymer having groups convertible to ion exchange groups (hereinafter also referred to as the fluorinated polymer (I′)) from a die of a melt-extruder to obtain a strand that contains the fluorinated polymer, and cutting the strand to obtain pellets that contain the fluorinated polymer. The present production method comprises an air-cooling treatment of cooling the strand extruded from the die by blowing air.

By the present production method, when an ion exchange membrane is formed by melt-extrusion, unevenness of the membrane thickness in the in-plane direction of the obtained ion exchange membrane is suppressed. The reason has not been clearly understood yet, but is considered to be as follows.

In a case where the strand extruded from the die is cooled with water, the fluorinated polymer and the water is in direct contact with each other, and hydrolysis of the groups convertible to ion exchange groups may occur. The hydrolysis is more likely to occur at the surface (a portion to be in direct contact with water) of the strand. Thus, it is considered that in the produced pellets, the hydrolysis occurs unevenly.

The present inventors have found that an ion exchange membrane formed by melt-extrusion using the pellets in which such hydrolysis occurred, has unevenness of the membrane thickness. The reason why such unevenness of the membrane thickness occurs is estimated to be as follows. That is, fluidity of the pellets when melted is different as between a hydrolyzed portion of the fluorinated polymer and a non-hydrolyzed portion of the fluorinated polymer, thus leading to unevenness of the membrane thickness at the time of melt-extrusion.

On the other hand, it is considered that according to the present production method, the strand is cooled by an air-cooling treatment, and thus hydrolysis of the groups convertible to ion exchange groups is less likely to occur. Accordingly, at the time of melt-extrusion, unevenness of the membrane thickness due to the difference in fluidity is less likely to occur, and as a result, unevenness of the membrane thickness in the in-plane direction of the obtained ion exchange membrane will be suppressed.

If no air is blown, the strand will not be sufficiently cooled and the strand is drawn at a relatively high temperature, and thus the strand is likely to deform thus leading to change in tension, and the thickness of the strand is less likely to be uniform. Pellets produced by cutting such a strand are likely to have a volume distribution, and when such pellets are melt-extruded, the melt may not be extruded at a constant discharge rate and as a result, the obtained ion exchange membrane may have uneven membrane thickness in the in-plane direction.

Now, an example of the present production method will be described.

First, a fluorinated polymer having groups convertible to ion exchange groups is supplied to a melt-extruder to obtain a melt of the fluorinated polymer.

The melt-extruder may be a known apparatus and specifically, a single screw extruder, a twin screw extruder or a tandem extruder may be mentioned.

The melting temperature of the fluorinated polymer (I′) is preferably 150 to 350° C., particularly preferably 200 to 300° C.

Then, the melt of the fluorinated polymer (I′) is extruded from a die at the tip of the melt-extruder, which is cooled to obtain a strand that contains the fluorinated polymer (I′), and the strand is cut into a predetermined size. In such a manner, pellets that contains the fluorinated polymer (I′) can be obtained.

At the time of conducting the above procedure to obtain the strand, in the present production method, an air-cooling treatment of blowing air to the strand extruded from the die is conducted.

“Blowing air” means that the linear velocity of the air is 0.3 m/sec or more, and with a view to achieving more uniform thickness of the strand and further reducing unevenness of the membrane thickness, the linear velocity of the air is preferably 0.6 m/sec or more, more preferably 5.0 m/sec or more, further preferably 10.0 m/sec or more, particularly preferably 20.0 m/sec or more. The linear velocity of the air may be 30.0 m/sec or more. The upper limit of the linear velocity of the air is not particularly limited and may be, for example, 50.0 m/sec or less, and may be 40.0 m/sec or less.

In the present disclosure, the linear velocity of the air is measured by an air speed meter, and its detailed measurement method is as described in Examples. The linear velocity of the air is preliminarily measured in the absence of the strand extruded from the die.

The air-cooling treatment of cooling the strand by blowing air is conducted preferably at least at a point with a distance from the die of 15 to 1 cm, more preferably 10 to 3 cm, further preferably 8 to 5 cm.

The range of the strand on which air is blown is 10 cm or more in the strand lengthwise direction, preferably 1 m or more, more preferably 3 m or more, further preferably 5 mm or more. The upper limit of the range of the stand on which air is blown is not particularly limited and may be, for example, 20 m or less.

For example, the air-cooling treatment of blowing air is conducted preferably by blowing air from the point within the above distance range from the die over the above range in the longitudinal direction of the strand.

The air may be blown on the strand at one position or at two or more positions. In a case where the air is blown on the strand at two or more positions, the linear velocities of the air at the two or more positions may be partly or entirely the same or different.

At the time of conducing the air-cooling treatment, the strand carrying rate is not particularly limited and is 10.0 m/min or less in many cases, preferably 5.0 m/min or less, more preferably 3.0 m/min or less. The strand carrying rate is 0.5 m/min or more in many cases, preferably 1.0 m/min or more, more preferably 2.0 m/min or more.

The carrying rate refers to a distance over which one point of the strand moves in one minute.

At the time of conducting the air-cooling treatment, the strand retention time in the region where the air-cooling treatment is conducted (for example, the range of the strand over which air is blown) may properly be adjusted. The retention time may be calculated by dividing the length of the region where the air-cooling treatment is conducted, by the carrying rate.

The retention time is 0.5 minutes or longer in many cases, preferably 1.0 minute or longer, more preferably 2.0 minutes or longer. The retention time is 10.0 minutes or shorter in many cases, preferably 7.0 minutes or shorter, more preferably 5.0 minutes or shorter.

The air to be blown in the cooling treatment may be humidity-modified air.

The moisture content in the air is, in that unevenness of the membrane thickness in the in-plane direction of the obtained ion exchange membrane will further be suppressed, preferably 55 g/m³ or less, more preferably 22 g/m³ or less, further preferably 18 g/m³ or less, particularly preferably 14 g/m³ or less. The lower limit of the moisture content in the air is not particularly limited and may be 3 g/m³ or more.

The temperature of the air to be blown in the cooling treatment may be adjusted.

The temperature of the air is preferably 45° C. or lower, more preferably 40° C. or lower, further preferably 30° C. or lower, particularly preferably 25° C. or lower. The lower limit of the temperature of the air is not particularly limited and is preferably 5° C. or higher, more preferably 10° C. or higher, further preferably 15° C. or higher.

The temperature of the die when the melt that contains the fluorinated polymer (I′) is extruded from the die (hereinafter also referred to as die temperature) is preferably lower than 300° C., more preferably 270° C. or lower, further preferably 260° C. or lower, particularly preferably 240° C. or lower, most preferably 200° C. or lower.

The die temperature is preferably 160° C. or higher, more preferably 180° C. or higher, in that the melt of the fluorinated polymer (I′) will readily be extruded from the die.

The shape of the pellets obtained by the present production method is not particularly limited and may, for example, be spherical (including ellipsoidal) or columnar (for example cylindrical).

The size of the pellets obtained by the present production method is not particularly limited and in a case where the pellets are cylindrical for example, the pellets preferably have a diameter of 2 to 3 mm and a length of 2 to 3 mm.

The pellets (strand) obtained by the present production method preferably have a plurality of grooves formed on their surface. By the grooves, adhesion of the pellets can be suppressed.

The grooves on the surface of the pellets may be formed on the entire surface of the pellets, however, they are usually formed preferably only on side surfaces of the pellets (surfaces other than the cut surfaces of the strand).

The grooves on the surface of the pellets are formed preferably mainly along the direction intersecting with the pellet cut surface (strand machine direction).

In the present production method, after the strand is cut, roughening treatment of roughening the surface of the pellets may be conducted. By this treatment, the surface of the pellets is further roughened to further suppress adhesion of the pellets, whereby an ion exchange membrane that achieves more excellent stability of the electrolysis voltage will be obtained.

The roughening treatment may be specifically, for example, conducted by stirring the pellets by a mixing machine (for example a V blender).

The pellets obtained by the present production method are preferably used for production of an ion exchange membrane. Specific examples of the application of the ion exchange membrane will be described later.

### [Fluorinated Polymer (I′)]

The fluorinated polymer (I′) used in the present production method is a fluorinated polymer having groups convertible to ion exchange groups. The groups convertible to ion exchange groups are preferably groups convertible to carboxylic acid functional groups or groups convertible to sulfonic acid functional groups.

The fluorinated polymer having groups convertible to ion exchange groups in the fluorinated polymer (I′) converted to ion exchange groups, that is the fluorinated polymer (I), has an ion exchange capacity of preferably 0.9 meq/g resin or more, more preferably 1.0 meq/g resin or more, further preferably 1.1 meq/g resin or more, particularly preferably 1.25 meq/g resin or more, with a view to reducing the electrolysis voltage of an apparatus having the resulting ion exchange membrane incorporated therein. Further, the ion exchange capacity is preferably 2.00 meq/g resin or less, more preferably 1.90 meq/g resin or less, further preferably 1.40 meq/g resin or less, in that the resulting ion exchange membrane has more excellent strength.

The fluorinated polymer (I) to measure the ion exchange capacity is obtained as follows. First, the fluorinated polymer (I′) vacuum heat-treated at 240° C. under −0.1 MPaG for 16 hours, is immersed in a dimethyl sulfoxide/potassium hydroxide/water=30/5.5/64.5 (mass ratio) solution at 95° C. for 30 minutes to hydrolyze and convert the groups convertible to ion exchange groups in the fluorinated polymer (I′) to K form ion exchange groups, and the polymer is washed with water. Then, the polymer is immersed in an aqueous sodium hydroxide solution to convert the terminal end groups from K form to Na form to obtain the fluorinated polymer (I) for measurement of the ion exchange capacity.

The ion exchange capacity of the fluorinated polymer (I) thus obtained may be measured as described in Examples.

Single type of the fluorinated polymer (I′) may be used or two or more types may be used in combination.

The fluorinated polymer (I′) is preferably a fluorinated polymer having groups convertible to carboxylic acid functional groups (hereinafter also referred to as the fluorinated polymer (C′)), or a fluorinated polymer having groups convertible to sulfonic acid functional groups (hereinafter also referred to as the fluorinated polymer (S′)) in that the effects of the present disclosure will further be achieved.

Now, each fluorinated polymer will be described in detail.

### (Fluorinated Polymer (C′))

The fluorinated polymer (C′) is preferably a copolymer of a fluorinated olefin and a monomer having a group convertible to a carboxylic acid functional group and a fluorine atom (hereinafter also referred to as fluorinated monomer (C′)) in that the effects of the present disclosure will further be achieved.

The copolymerization method may be a known method such as solution polymerization, suspension polymerization or emulsion polymerization.

The fluorinated monomer (C′) is not particularly limited so long as it is a compound having one or more fluorine atoms, having an ethylenic double bond and having a group convertible to a carboxylic acid functional group, and a known compound may be used.

The fluorinated monomer (C′) is preferably a monomer represented by the following formula (1) in terms of the monomer production cost, the reactivity with other monomers and the ability to give the fluorinated polymer with excellent properties.

CF₂═CF—(O)ₚ—(CF₂)_{q}—(CF₂CFX)ᵣ—(O)ₛ—(CF₂)ₜ—(CF₂CFX′)ᵤ-A¹ Formula (1)

In the formula (1), X and X′ are each independently a fluorine atom or a trifluoromethyl group. A¹ is a group convertible to a carboxylic acid functional group. Specifically, it may be —CN, —COF, —COOR¹ (R¹ is a C₁₋₁₀ alkyl group), or —COONR²R³ (R² and R³ are each independently a hydrogen atom or a C₁₋₁₀ alkyl group). p is an integer of 0 or 1. q is an integer of 0 to 12. r is an integer of 0 to 3. s is an integer of 0 or 1. t is an integer of 0 to 12. u is an integer of 0 to 3. 1≤p+s, and 1≤r+u.

Specific examples of the monomer represented by the formula (1) may be the following compounds, and in view of easiness of production, preferred is a compound wherein p=1, q=0, r=1, s=0 to 1, t=0 to 3, and u=0 to 1.
CF₂═CF—O—CF₂CF₂—COOCH₃,
CF₂═CF—O—CF₂CF₂CF₂—COOCH₃,
CF₂═CF—O—CF₂CF₂CF₂CF₂—COOCH₃,
CF₂═CF—O—CF₂CF₂—O—CF₂CF₂—COOCH₃,
CF₂═CF—O—CF₂CF₂—O—CF₂CF₂CF₂—COOCH₃,
CF₂═CF—O—CF₂CF₂—O—CF₂CF₂CF₂CF₂—COOCH₃,
CF₂═CF—O—CF₂CF₂CF₂—O—CF₂CF₂—COOCH₃,
CF₂═CF—O—CF₂CF(CF₃)—O—CF₂CF₂—COOCH₃,
CF₂═CF—O—CF₂CF(CF₃)—O—CF₂CF₂CF₂—COOCH₃.

Single type of the fluorinated monomer (C′) may be used or two or more types may be used in combination.

The fluorinated olefin may be a C₂₋₃ fluoroolefin having one or more fluorine atoms in its molecule. Specific examples thereof include tetrafluoroethylene (TFE), chlorotrifluoroethylene, vinylidene fluoride, vinyl fluoride and hexafluoropropylene. Among them, TFE is particularly preferred, in terms of the monomer production cost, the reactivity with other monomers and the ability to give the fluorinated polymer with excellent properties.

Single type of the fluoroolefin may be used or two or more types may be used in combination.

For production of the fluorinated polymer (C′), in addition to the fluorinated monomer (C′) and the fluorinated olefin, other monomer may further be used. Specific examples of the other monomer include CF₂═CFR^{f} (R^{f} is a C₂₋₁₀ perfluoroalkyl group), CF₂═CF—OR^{f1} (R^{f1} is a C₁₋₁₀ perfluoroalkyl group) and CF₂═CFO(CF₂)ᵥCF═CF₂ (v is an integer of 1 to 3). By copolymerizing the other monomer, it is possible to improve flexibility and mechanical strength of the ion exchange membrane.

The content of the units based on the other monomer is preferably 30 mass % or less to all units in the fluorinated polymer (C′) with a view to maintaining the ion exchange performance.

### (Fluorinated Polymer (S′))

The fluorinated polymer (S′) is preferably a copolymer of a fluorinated olefin and a monomer having a group convertible to a sulfonic acid functional group and a fluorine atom (hereinafter also referred to as the fluorinated monomer (S′)), in that the effects of the present disclosure will further be achieved.

The copolymerization method may be a known method such as solution polymerization, suspension polymerization or emulsion polymerization.

The fluorinated olefin may be the above exemplified ones, and is preferably TFE in terms of the monomer production cost, the reactivity with other monomers and the ability to give the fluorinated polymer (S′) with excellent properties.

Single type of the fluorinated olefin may be used, or two or more types may be used in combination.

The content of the units based on the fluorinated olefin to all units contained in the fluorinated polymer (S′) is preferably 65 to 95 mol %.

The fluorinated monomer (S′) may be a compound having one or more fluorine atoms in its molecule, having an ethylenic double bond and having a group convertible to a sulfonic acid functional group.

The fluorinated monomer (S′) is, in terms of the monomer production cost, the reactivity with other monomers and the ability to give the fluorinated polymer (S′) with excellent properties, preferably the compound represented by the formula (2):

CF₂═CF-L-(A)ₙ formula (2)

L is a (n+1)-valent perfluorohydrocarbon group which may contain an oxygen atom.

The oxygen atom may be located at a terminal end or may be located between carbon atoms of the perfluorohydrocarbon group.

The number of carbon atoms in the (n+1)-valent perfluorohydrocarbon group is preferably 1 or more, more preferably 2 or more, and is preferably 20 or less, more preferably 10 or less.

As L, preferred is a (n+1)-valent perfluoroaliphatic hydrocarbon group which may contain an oxygen atom. More preferred is a divalent perfluoroalkylene group which may contain an oxygen atom as corresponding to an embodiment of n=1, or a trivalent perfluoroaliphatic hydrocarbon group which may contain an oxygen atom as corresponding to an embodiment of n=2. The above-mentioned divalent perfluoroalkylene group may be linear or branched.

n is an integer of 1 or 2.

A is a group convertible to a sulfonic acid functional group. The group convertible to a sulfonic acid functional group is preferably a functional group convertible to a sulfonic acid functional group by hydrolysis. Specific examples of the group convertible to a sulfonic acid functional group include —SO₂F, —SO₂Cl, and —SO₂Br. When n is 2, the two A may be the same or different.

The compound represented by the formula (2) is preferably a compound represented by the formula (2-1), a compound represented by the formula (2-2), a compound represented by the formula (2-3) or a compound represented by the formula (1-4).

CF₂═CF—O—R^{f1}-A formula (2-1)

CF₂═CF—R^{f1}-A formula (2-2)

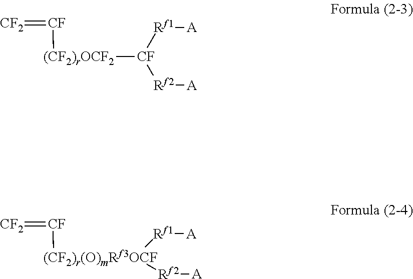

R^{f1} is a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f2} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

r is 0 or 1.

In the formulae, R^{f2} is a single bond or a perfluoroalkylene group which may contain an oxygen atom between carbon atoms.

In the formulae, A is as defined above.

R^{f3} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

r is 0 or 1.

m is 0 or 1.

Specific examples of the compound represented by the formula (2-1) include the following compounds. In the formulae, w is an integer of 1 to 8, and x is an integer of 1 to 5.
CF₂═CF—O—(CF₂)_{w}—SO₂F
CF₂═CF—O—CF₂CF(CF₃)—O—(CF₂)_{w}—SO₂F
CF₂═CF—[O—CF₂CF(CF₃)]ₓ—SO₂F

Specific examples of the compound represented by the formula (2-2) include the following compounds. In the formulae, w is an integer of 1 to 8.
CF₂═CF—(CF₂)_{w}—SO₂F
CF₂═CF—CF₂—O—(CF₂)_{w}—SO₂F

As the compound represented by the formula (2-3), a compound represented by the formula (2-3-1) is preferred. In the formula, R^{f4} is a C₁₋₆ linear perfluoroalkylene group, and R^{f5} is a single bond or a C₁₋₆ linear perfluoroalkylene group which may contain an oxygen atom between carbon atoms. In the formula, r and A are as defined above.

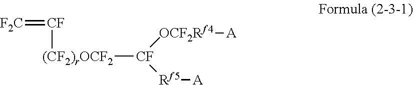

Specific examples of the compound represented by the formula (2-3-1) are as follows.

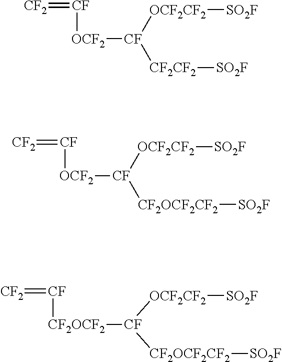

The compound represented by the formula (2-4) is preferably a compound represented by the formula (2-4-1).

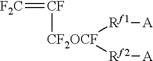

In the formula, R^{f1}, R^{f2} and A are as defined above.

Specific examples of the compound represented by the formula (2-4-1) are as follow.

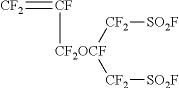

Single type of the fluorinated monomer (S′) may be used, or two or more types may be used in combination.

The content of the units based on the fluorinated monomer (S′) to all units in the fluorinated polymer (S′) is preferably 5 to 35 mol %.

For production of the fluorinated polymer (S′), in addition to the fluorinated olefin and the fluorinated monomer (S′), other monomer may further be used. The other monomer may be as exemplified above.

The content of the units based on the other monomer is preferably 30 mass % or less to all units in the fluorinated polymer (S′) with a view to maintaining the ion exchange performance.

### [Pellets]

The pellets obtained by the production method of the present disclosure (hereinafter also referred to as the present pellets) contain the fluorinated polymer having groups convertible to ion exchange groups (fluorinated polymer (I′)).

By using the present pellets, when an ion exchange membrane is formed by melt-extrusion, an ion exchange membrane of which unevenness of the membrane thickness in the in-plane direction is suppressed can be formed. The reason is as described above.

The light transmittance of the present pellets is preferably 30 to 60%, more preferably 30 to 50%, further preferably 30 to 40%. The present pellets having the light transmittance within the above range are estimated to have roughened surface, and thus considered to be such that the contact area between the pellets is small and adhesion between the pellets is suppressed. Thus, a pressure variation at the time of forming the film is suppressed, and an ion exchange membrane being more excellent in uniformity of the membrane thickness can be obtained.

The light transmittance of the present pellets refers to a visible light transmittance (measurement wavelength 400 to 700 nm) measured by using a luminous transmissometer (manufactured by Asahi Spectra Co., Ltd., MODEL 304 or equivalent apparatus), and the specific measurement method is as follows.

The luminous transmissometer is adjusted so that the visible light transmittance will be 100% without the above-described sample holder placed on a sample table. Then, a sample holder having a hole with a predetermined size (for example a rectangular hole of 2 to 3 mm×2 to 3 mm) in which a pellet is to be inserted, is placed on the sample table, and the light intensity is adjusted so that the visible light transmittance without a pellet inserted into the hole of the sample holder will be 25%.

Then, a pellet of the same size as the hole of the sample holder is inserted into the hole of the sample holder, and the visible light transmittance is measured. Measurement of the visible light transmittance of the pellet is conducted on several positions for one pellet, and the arithmetic mean is obtained. For example, in a case where the pellet is cylindrical, the pellet is inserted into the hole of the sample holder so that the side surface of the pellet is irradiated with light, the pellet is rotated by 90 degrees at a time in the circumferential direction to measure the visible light transmittance at three positions on one pellet, and the arithmetic mean is obtained.

And, the visible light transmittance of the pellet is calculated, based on the visible light transmittance (25%) before the pellet is inserted into the hole of the sample holder being 100% (that is, the measured visible light transmittance of the pellet is multiplied by 4), and is taken as the light transmittance (%) of the present pellets.

The hydrolysis rate of the present pellets is less than 1.00%, and is preferably less than 0.50%, more preferably less than 0.30%, further preferably less than 0.10%.

The fluorinated polymer (I′) contained in the present pellets is the same as the fluorinated polymer (I′) used in the above present production method, and preferred embodiments of the ion exchange capacity, etc., are also the same.

The shape, the size, the surface state and the applications of the present pellets are also the same as the pellets obtained by the above present production method.

### [Ion Exchange Membrane]

Now, an ion exchange membrane obtained by using the present pellets (hereinafter also referred to as the present ion exchange membrane) will be described.

As an example of the preferred method for producing the present ion exchange membrane may be as follows. That is, using the present pellets, a precursor membrane that contains the fluorinated polymer having groups convertible to ion exchange groups ((the fluorinated polymer (I′)) is formed and then the groups convertible to ion exchange groups contained in the precursor membrane are converted to in exchange groups thereby to obtain the present ion exchange membrane that contains the fluorinated polymer having ion exchange groups (the fluorinated polymer (I)).

### [Precursor Membrane Production Method]

As the precursor membrane production method, extrusion may be mentioned. Specifically, the present pellets are supplied to a known melt-extruder for film production and a melt of the present pellets is extruded into a film from a nozzle (for example a T die) of the melt-extruder to obtain the precursor membrane. That is, as the precursor membrane production method, specifically, melt-extrusion may be mentioned. The melting temperature of the present pellets is preferably 150 to 350° C., particularly preferably 200 to 300° C.

The precursor membrane may have a reinforcing material embedded therein. The reinforcing material may be embedded in the precursor membrane by a known method. For example, in a case where an ion exchange membrane having a multilayered structure is to be formed, the reinforcing material is sandwiched between the precursor membranes. Further, the reinforcing material may be embedded in the precursor membrane also by a method of coating both surfaces of the reinforcing material with a melt of the present pellets.

Specific examples of the reinforcing material include a reinforcing fabric (preferably woven fabric), fibrils and a porous body, and among them, a reinforcing fabric is preferred.

### [Ion Exchange Membrane Production Method]

The present ion exchange membrane that contains the fluorinated polymer (I) may be obtained by converting groups convertible to ion exchange groups of the fluorinated polymer (I′) contained in the precursor membrane to ion exchange groups.

The conversion of the groups convertible to ion exchange groups in the precursor membrane to ion exchange groups may be carried out by, for example, subjecting the precursor membrane to treatment such as hydrolysis and conversion to acid form.

In particular, preferred is contact treatment of the precursor membrane with an aqueous alkaline solution.

The contact treatment of the precursor membrane with the aqueous alkaline solution may be performed by, for example, immersion of the precursor membrane in the aqueous alkaline solution, spraying of the aqueous alkaline solution onto the surface of the precursor membrane, or the like.

The temperature of the aqueous alkaline solution is preferably 30° C. or higher and less than 100° C. in terms of the productivity of the ion exchange membrane, and the contact time of the precursor membrane and the aqueous alkaline solution is preferably 3 to 300 minutes.

The aqueous alkaline solution preferably contains an alkali metal hydroxide, a water-soluble organic solvent and water. Specific examples of the alkali metal hydroxide include sodium hydroxide and potassium hydroxide, and potassium hydroxide is preferred. Single type of the alkali metal hydroxide may be used or two or more types may be used in combination.

In this specification, the water-soluble organic solvent refers to an organic solvent easily soluble in water. Specifically, preferred is an organic solvent with a solubility of 0.1 g or more in 1000 ml of water (20° C.), and an organic solvent with a solubility of 0.5 g or more is more preferred. The water-soluble organic solvent preferably contains at least one kind selected from the group consisting of aprotic organic solvents, alcohols and amino alcohols, and more preferably contains an aprotic organic solvent.

Single type of the water-soluble organic solvent may be used or two or more types may be used in combination.

Specific examples of the aprotic organic solvents include dimethyl sulfoxide, N,N-dimethylformamide, N, N-dimethylacetamide, N-methyl-2-pyrrolidone and N-ethyl-2-pyrrolidone. Preferred is dimethyl sulfoxide.

Specific examples of the alcohols include methanol, ethanol, isopropanol, butanol, methoxyethoxyethanol, butoxyethanol, butylcarbitol, hexyloxyethanol, octanol, 1-methoxy-2-propanol and ethylene glycol.

Specific examples of the amino alcohols include ethanolamine, N-methyl ethanolamine, N-ethyl ethanolamine, 1-amino-2-propanol, 1-amino-3-propanol, 2-aminoethoxyethanol, 2-aminothioethoxyethanol and 2-amino-2-methyl-1-propanol.

The content of the alkali metal hydroxide in the aqueous alkaline solution is preferably 1 to 60 mass %.

The content of the water-soluble organic solvent in the aqueous alkaline solution is preferably 1 to 60 mass %.

When the contents of the alkali metal hydroxide and the water-soluble organic solvent are within the above ranges, the hydrolysis treatment will quickly be completed, thus improving the productivity of the present ion exchange membrane.

The content of water in the aqueous alkaline solution is preferably 39 to 80 mass %.

After the contact of the precursor membrane with the aqueous alkaline solution, a treatment for removing the aqueous alkaline solution may be performed. The aqueous alkaline solution may be removed by, for example, washing, with water, the present ion exchange membrane contact-treated with the aqueous alkaline solution.

After the contact of the precursor membrane with the aqueous alkaline solution, the thus-obtained ion exchange membrane may be dried. The drying treatment is preferably heat treatment, and the heating temperature is preferably 50 to 160° C. The heating time is preferably 0.1 to 24 hours.

After the groups convertible to ion exchange groups in the precursor membrane are converted to ion exchange groups, the present ion exchange membrane may be brought into contact with an aqueous solution containing potassium ions, sodium ions or hydrogen ions to replace the counter ions (cations) of the ion exchange groups. By replacing the cations of the ion exchange groups with the same cations as the cations present in the aqueous alkali, the present ion exchange membrane may be subjected to alkali water electrolysis in an environment where the cations used for the replacement are present, thus improving dimensional stability of the present ion exchange membrane.

The precursor membrane or the present ion exchange membrane may have a hydrophilic layer formed on its surface. The hydrophilic layer may be formed on at least one surface of the precursor membrane or the present ion exchange membrane.

The hydrophilic layer may be, for example, an inorganic particle layer containing inorganic particles. The inorganic particles are preferably ones having excellent corrosion resistance to an acid or an alkali and having hydrophilicity. Specifically, they are preferably particles of at least one member selected from the group consisting of oxides, nitrides and carbides of Group 4 elements and Group 14 elements, more preferably at least one member selected from the group consisting of SiO₂, SiC, ZrO₂ and ZrC, particularly preferably ZrO₂.

The hydrophilic layer may contain a binder. The binder may be a known biner used for a known hydrophilic layer (gas lease layer), and for example, methyl cellulose or a fluorinated polymer having a sulfonic acid group may be mentioned.

The hydrophilic layer may be formed, for example, by applying a solution containing the inorganic particles and the binder to the precursor membrane or the present ion exchange membrane.

The present ion exchange membrane may be a single layer or may have a multilayered structure. The ion exchange membrane having a multilayered structure may be produced, for example, by using a precursor membrane obtained by stacking a plurality of layers each containing a fluorinated polymer having groups convertible to ion exchange groups by co-extrusion.

The membrane thickness of the present ion exchange membrane is, with a view to keeping a certain strength, preferably 30 μm or more, more preferably 40 μm or more, and with a view to increasing the current efficiency and the voltage efficiency, preferably 500 μm or less, more preferably 300 μm or less, further preferably 180 μm or less.

### [Fluorinated Polymer (I)]

The fluorinated polymer (I) is a fluorinated polymer obtained by converting groups convertible to ion exchange groups of the fluorinated polymer (I′) contained in the precursor membrane, to ion exchange groups.

The fluorinated polymer (I) is preferably a fluorinated polymer having carboxylic acid functional groups (hereinafter also referred to as the fluorinated polymer (C)) or a fluorinated polymer having sulfonic acid functional groups (hereinafter also referred to as the fluorinated polymer (S)), in that the effects of the present disclosure will further be achieved.

Now, each fluorinated polymer will be described in detail below.

### (Fluorinated Polymer (C))

The fluorinated polymer (C) is obtained preferably by converting the groups convertible to carboxylic acid functional groups of the fluorinated polymer (C′) to carboxylic acid functional groups.

The fluorinated polymer (C) preferably has units based on a fluorinated olefin and units based on a monomer having a carboxylic acid functional group and a fluorine atom.

The fluorinated olefin may be ones as exemplified above.

Single type of the units based on the fluoroolefin may be contained or two or more types may be used in combination.

The units based on the monomer having a carboxylic acid functional group and a fluorine atom are preferably units represented by the following formula (1C).

—[CF₂—CF((O)ₚ—(CF₂)_{q}—(CF₂CFX)ᵣ—(O)ₛ—(CF₂)ₜ—(CF₂CFX′)ᵤ—COOM^{C})]- Formula (1C)
M^{C} is a hydrogen atom, an alkali metal or a quaternary ammonium cation.
X, X′, p, q, r, s, t and u are the same as those in the formula (1).

Specific examples of the units represented by the formula (1C) include the following units, and preferred is a compound wherein p=1, q=0, r=1, s=0 to 1, t=0 to 3, and u=0 to 1.
—[CF₂—CF(O—CF₂CF₂—COOM^{C})]—,
—[CF₂—CF(O—CF₂CF₂CF₂—COOM^{C})]—,
—[CF₂—CF(O—CF₂CF₂CF₂CF₂—COOM^{C})]—;
—[CF₂—CF(O—CF₂CF₂—O—CF₂CF₂—COOM^{C})]—,
—[CF₂—CF(O—CF₂CF₂—O—CF₂CF₂CF₂—COOM^{C})]—,
—[CF₂—CF(O—CF₂CF₂—O—CF₂CF₂CF₂CF₂—COOM^{C})]—,
—[CF₂—CF(O—CF₂CF₂CF₂—O—CF₂CF₂—COOM^{C})]—,
—[CF₂—CF(O—CF₂CF(CF₃)—O—CF₂CF₂—COOM^{C})]—,
—[CF₂—CF(O—CF₂CF(CF₃)—O—CF₂CF₂CF₂—COOM^{C})]—.

Single type of the units based on the monomer having a carboxylic acid functional group and a fluorine atom may be contained, or two or more types may be contained.

The fluorinated polymer (C) may contain, in addition to the units based on the fluorinated olefin and the units based on the monomer having a carboxylic acid functional group and a fluorine atom, units based on other monomer.

The other monomer may be, for example, the above exemplified ones. The content of the units based on the other monomer is preferably 30 mass % or less to all units in the fluorinated polymer (C), with a view to maintaining the ion exchange capacity.

### (Fluorinated Polymer (S))

The fluorinated polymer (S) is obtained preferably by converting the groups convertible to sulfonic acid functional groups of the fluorinated polymer (S′) to sulfonic acid functional groups.

The fluorinated polymer (S) preferably has units based on a fluorinated olefin and units based on a monomer having a sulfonic acid functional group and a fluorine atom.

The fluorinated olefin may be as exemplified above.

Single type of the units based on the fluoroolefin may be contained or two or more types may be contained.

The units based on the monomer having a sulfonic acid functional group and a fluorine atom are preferably units based on the formula (2S).

—[CF₂—CF(-L-(SO₃M^{S})ₙ)]- Formula (2S)

In the formula (2S), L and n are as defined for the formula (2).

M^{S} is a hydrogen atom, an alike metal or a quaternary ammonium cation. When n is 2, the two M^{S} may be the same or different.

The units represented by the formula (2S) are preferably units represented by the formula (2S-1), units represented by the formula (2S-2), unit represented by the formula (2S-3), or units represented by the formula (2S-4):

—[CF₂—CF(—O—R^{f1}—SO₃M^{S})]- Formula (2S-1)

—[CF₂—CF(—R^{f1}—SO₃M^{S})]- Formula (2S-2)

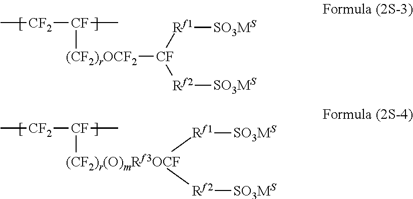

In the formulae (2S-1) to (2S-4), R^{f1}, R^{f2}, R^{f3}, r and m are as defined for the formula a (2-1) to the formula (2-4).

M^{S} is a hydrogen atom, an alkali metal or a quaternary ammonium cation.

Specific examples of the units represented by the formula (2S-1) are the following units. In the formulae, w is an integer of 1 to 8, and x is an integer of 1 to 5. In the formula, M^{S} is as defined above.
—[CF₂—CF(—O—(CF₂)_{w}—SO₃M^{S})]—
—[CF₂—CF(—O—CF₂CF(CF₃)—O—(CF₂)_{w}—SO₃M^{S})]—
—[CF₂—CF(—(O—CF₂CF(CF₃))ₓ—SO₃M^{S})]—

Specific examples of the units represented by the formula (2S-2), the following units may be mentioned. In the formula, w is an integer of 1 to 8. In the formula, M^{S} is as defined above.
—[CF₂—CF(—(CF₂)_{w}—SO₃M^{S})]—
—[CF₂—CF(—CF₂—O—(CF₂)_{w}—SO₃M^{S})]—

The units represented by the formula (2S-3) are preferably units represented by the formula (2S-3-1). In the formula, M^{S} is as defined above.

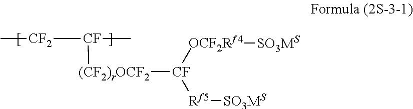

In the formula (2S-3-1). R^{f4}, R^{f5} and r are as defined for the formula (2-3-1). M^{S} is as defined above.

Specific examples of the units represented by the formula (2S-3) are as follows.

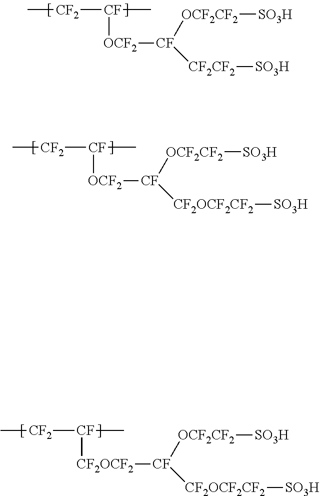

The units represented by the formula (2S-4) are preferably units represented by the formula (2S-4-1). In the formula, R^{f1}, R^{f2} and M are as defined above.

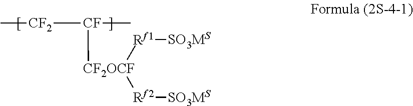

Specific examples of the units represented by the formula (2S-4-1) are as follows.

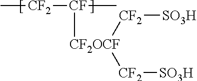

Single type of the units based on the monomer having a sulfonic acid functional group and a fluorine atom may be contained, or two or more types may be contained.

The fluorinated polymer (S) may contain, in addition to the units based on the fluorinated olefin, and the units based on the monomer having a sulfonic acid functional group and a fluorine atom, units based on other monomer.

Specific examples of the other monomer include the above-exemplified ones. The content of the units base on the other monomer is preferably 30 mass % or less to all unit in the fluorinated polymer (S), with a view to maintaining the ion exchange capacity.

### [Application of Ion Exchange Membrane]

Specific examples of the application of the present ion exchange membrane include various batteries such as polymer electrolyte fuel cells, direct methanol fuel cells, redox flow batteries and air batteries, and various electrolyzers for polymer electrolyte membrane water electrolysis, alkali water electrolysis, ozone water electrolysis, chlor-alkali electrolysis, organic electrolysis, and electrolysis of chloride, oxide, and the like. In addition, the present ion exchange membrane may be used for selective cation transport at the membrane-electrode interface as a separator or a solid electrode in various types of electrochemical cells. Further, in addition to the electrochemical applications, it may be used for gas sensors, biosensors, luminous devices, optical devices and organic sensors, solubilization of carbon nanotubes, actuators, catalysts, etc.

### EXAMPLES

Now, the present invention will be described in detail with reference to Examples. However, it should be understood that the present invention is by no means restricted to such specific Examples. In Tables described later, the amount of each component is based on mass.

Ex. 1 to 9 correspond to Examples of the present invention, and Ex. 10 to 12 correspond to Comparative Examples.

### [Ion Exchange Capacity of Fluorinated Polymer]

A fluorinated polymer having ion exchange groups was stored in a glove box purged with dry nitrogen for 24 hours and then the dry mass of the fluorinated polymer was measured. Then, the fluorinated polymer was immersed in a 2 mol/L aqueous sodium chloride solution at 60° C. for 1 hour. After the fluorinated polymer was washed with ultrapure water and recovered, the solution in which the fluorinated polymer had been immersed was titrated with 0.1 mol/L aqueous sodium hydroxide solution to determine the ion exchange capacity of the fluorinated polymer (meq/g resin).

### [Production of Fluorinated Polymer (S′-1)]

CF₂═CF₂ and monomer (X1) represented by the following formula (X1) were copolymerized to obtain fluorinated polymer (S′-1) (ion exchange capacity: 1.00 meq/g resin). The blend ratio of the monomers was adjusted to so that the fluorinated polymer (S′-1) would have the above ion exchange capacity.

CF₂═CF—O—CF₂CF(CF₃)—O—CF₂CF₂—SO₂F (X1)

### [Production of Fluorinated Polymer (S′-2)]

CF₂═CF₂ and monomer (X1) represented by the above formula (X1) were copolymerized to obtain fluorinated polymer (S′-2) (ion exchange capacity: 1.10 meq/g resin). The blend ratio of the monomers was adjusted so that the fluorinated polymer (S′-2) would have the above ion exchange capacity.

### [Production of Fluorinated Polymer (S′-3)]

CF₂═CF₂ and monomer (X1) represented by the above formula (X1) were copolymerized to obtain fluorinated polymer (S′-3) (ion exchange capacity: 1.25 meq/g resin). The blend ratio of the monomers was adjusted so that the fluorinated polymer (S′-3) would have the above ion exchange capacity.

### [Production of Fluorinated Polymer (S′-4)]

CF₂═CF₂ and monomer (X2) represented by the above formula (X2) were copolymerized to obtain fluorinated polymer (S′-4) (ion exchange capacity: 1.90 meq/g resin). The blend ratio of the monomers was adjusted so that the fluorinated polymer (S′-4) would have the above ion exchange capacity.

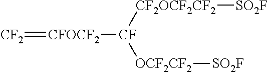

### [Production of Fluorinated Polymer (C′-1)]

CF₂═CF₂ and monomer (Y1) represented by the following formula (Y1) were copolymerized to obtain fluorinated polymer (C′-1) (ion exchange capacity: 1.05 meq/g resin). The blend ratio of the monomers was adjusted so that the fluorinated polymer (C′-1) would have the above ion exchange capacity.

CF₂═CF—O—CF₂CF₂CF₂—COOCH₃ (Y1)

The ion exchange capacity in each of the above-described [Production of fluorinated polymer (S′-1)] to [Production of fluorinated polymer (S′-3)], and [Production of fluorinated polymer (C′-1)] means to the ion exchange capacity of a fluorinated polymer having ion exchange groups obtained by treating each of the fluorinated polymers (S′-1) to (S′-3) and (C′-1) in the following procedure. First, the fluorinated polymer having groups convertible to ion exchange groups, vacuum heat-treated at 240° C. under −0.1 MPaG for 16 hours, was immersed in a dimethyl sulfoxide/potassium hydroxide/water=30/5.5/64.5 (mass ratio) solution at 95° C. for 30 minutes to hydrolyze and convert the groups convertible to ion exchange groups in the fluorinated polymer to K-form ion exchange groups, and the polymer was washed with water. The polymer was then immersed in an aqueous sodium hydroxide solution to convert the terminal end groups from K form to Na form, thereby to obtain a fluorinated polymer for measurement of the ion exchange capacity.

### Ex. 1

The fluorinated polymer (C′-1) was supplied to a melt-extruder for pellet production to obtain a melt of the fluorinated polymer (C′-1). The melt was extruded from a die heated to 190° C. and cooled by blowing air to obtain a strand (diameter: 3.0 mm). The strand was cut into a length of 3.0 mm to obtain pellets of the fluorinated polymer (C′-1).

The cooling by blowing air was conducted at a linear velocity of the air of 2 m/sec. The blowing of air was conducted from a point where the strand extruded from the die became 10 cm to a point of 5 m opposite from the die. The linear velocity of the air was measured before the extrusion and the cooling were conducted. The linear velocity of the air was a value measured at a point where the strand extruded from the die became 10 cm, by an air speed meter (vane air speed meter, testo 416).

The strand carrying rate was 2.5 m/min.

The air to be blown in the above procedure was preliminarily measured and found to have a temperature of 25° C. and a relative humidity of 61%. That is, the air had a moisture content of 14 g/m³. In Table described later, the moisture content of the air is represented by the unit g/m³.

### [Measurement of Hydrolysis Rate]

The obtained pellets were subjected to Fourier transform infrared spectrophotometer (manufactured by Shimadzu Corporation, IRTracer-100) to calculate area intensities of a peak attributable to the group convertible to an ion exchange group (—COOCH₃)(—CH₃, 2883 to 3180 cm⁻¹) and a peak attributable to the ion exchange group (—COOH)(—OH, 3180 to 3450 cm⁻¹).

The ratio of the area intensity of the ion exchange group to the sum of the area intensity of the group convertible to an ion exchange group and the area intensity of the ion exchange group, was taken as the hydrolysis rate (unit: %). The hydrolysis rate is shown in Table 1 described later.

Then, the pellets of the fluorinated polymer (S′-1) were supplied to a melt-extruder for film production to melt the pellets at 260° C. to obtain a melt of the pellets of the fluorinated polymer (S′-1). The obtained melt was extruded from a T die into a film shape to obtain a precursor membrane formed of the fluorinated polymer (S′-1).

The precursor membrane was immersed in a dimethyl sulfoxide/potassium hydroxide/water=30/5.5/64.5 (mass ratio) solution at 95° C. for 30 minutes to hydrolyze and convert the groups convertible to sulfonic acid functional groups in the precursor membrane to K form sulfonic acid functional groups, and the membrane was washed with water. The membrane was then immersed in an aqueous sodium hydroxide solution to convert the terminal end groups from K form to Na form, and the membrane was dried to obtain an ion exchange membrane having a membrane thickness of 30 μm. The obtained ion exchange membrane was subjected to the following evaluation.

[Unevenness of Membrane Thickness in in-Plane Direction of Ion Exchange Membrane]

The unevenness of the membrane thickness in the in-plane direction of the ion exchange membrane obtained by the after-described procedure was measured. The thicknesses on arbitrary 100 points in a 20 cm square of the obtained ion exchange membrane were measured by a contact membrane thickness meter, and the unevenness of the membrane thickness in the in-plane direction of the ion exchange membrane was evaluated based on the following standards. For practical application, grade A or B is preferred, and grade A is more preferred.
A: thicknesses at any of arbitrary 100 points being 30 μm+2 μm.
B: thicknesses at any of arbitrary 100 points being 30 μm+3 μm, although several of which not being 30 μm±2 μm.
C: thicknesses at any of arbitrary 100 points being out of 30 μm±3 μm.

### Ex. 2 to 9

The same operation as in Ex. 1 was conducted except that one or more among the type of the fluorinated polymer for pellet production, the linear velocity of the air to be blown at the time of pellet production, and the moisture content of the air were changed as shown in Table 1 described later, to prepare pellets and an ion exchange membrane, which were subjected to the above measurement and evaluation. The results are shown in Table 1.

In measurement of the hydrolysis rate, in a case where the groups convertible to ion exchange groups are —SO₂F, the hydrolysis rate was obtained by the following procedure.

First, from the ion exchange capacity obtained by the above method, the number of ion exchange groups was obtained. Using a 1M aqueous potassium chloride solution, the pellets in a predetermined amount were subjected to extraction treatment at 50° C. for 16 hours to obtain an extract liquid. By this extraction treatment, the pellets in which the groups convertible to ion exchange groups (—SO₂F) were hydrolyzed and converted to ion exchange groups (—SO₃H), in the pellets, were extracted to an extract liquid. The extract liquid was titrated with an alkaline reagent to calculate the number of ion exchange groups (—SO₃H).

The ratio of the number of ion exchange groups (—SO₃H) to the number of ion exchange groups, obtained by the above procedure, was taken as the hydrolysis rate (unit: %).

### Ex. 10 and 12

The same operation as in Ex. 1 was conducted except that the melt was extruded from the die and cooled with water at 40° C. or lower, to prepare pellets and an ion exchange membrane, which were subjected to the above measurement and evaluation. The results are shown in Table 1.

### Ex. 11

The same operation as in Ex. 1 was conducted except that the melt was extruded from the die and cooled in air without blowing air, to prepare pellets and an ion exchange membrane, which were subjected to the above measurement and evaluation. The results are shown in Table 1.

TABLE 1

| | | | | | Moisture | | | Unevenness of the |
|---|---|---|---|---|---|---|---|---|
| | | Ion exchange | | | content | Linear | Pellet | membrane |
| | Type of | capacity | Strand cooling | Temperature | of air | velocity | hydrolysis | thickness in in- |
| | polymer | [meq/g] | method | [° C.] | [g/m³] | [m/sec] | rate [%] | plane direction |
| Ex. 1 | C′-1 | 1.05 | Air cooling | 25 | 14 | 20.0 | 0.03 | A |
| Ex. 2 | C′-1 | 1.05 | Air cooling | 25 | 22 | 20.0 | 0.04 | A |
| Ex. 3 | C′-1 | 1.05 | Air cooling | 40 | 49 | 20.0 | 0.10 | B |
| Ex. 4 | C′-1 | 1.05 | Air cooling | 25 | 14 | 5.0 | 0.03 | B |
| Ex. 5 | S′-1 | 1.00 | Air cooling | 25 | 14 | 20.0 | 0.01 | A |
| Ex. 6 | S′-2 | 1.10 | Air cooling | 25 | 14 | 20.0 | 0.01 | A |
| Ex. 7 | S′-3 | 1.25 | Air cooling | 25 | 14 | 20.0 | 0.01 | A |
| Ex. 8 | S′-3 | 1.25 | Air cooling | 40 | 49 | 20.0 | 0.07 | B |
| Ex. 9 | S′-4 | 1.90 | Air cooling | 25 | 14 | 20.0 | 0.01 | A |
| Ex. 10 | C′-1 | 1.05 | Water cooling | 40 | — | — | 5.00 | C |
| Ex. 11 | C′-1 | 1.05 | Air cooling | 25 | 14 | 0.0 | 0.03 | C |
| Ex. 12 | S′-3 | 1.25 | Water cooling | 40 | — | — | 1.00 | C |

It was found from the results shown in Table 1 that in Ex. 10 and 12 in which the strand was cooled with water, the hydrolysis rates were 5.00% and 1.00%, and the obtained ion exchange membranes had significant unevenness of the membrane thickness in the in-plane direction.

Further, in Ex. 11 in which the strand was cooled without blowing air, although the hydrolysis rate was 0.03%, the obtained ion exchange membrane had significant unevenness of the membrane thickness in the in-plane direction.

Whereas in Ex. 1 to 9 in which the strand was cooled by blowing air, the obtained ion exchange membrane had small unevenness of the membrane thickness in the in-plane direction.

It was confirmed from comparison between Ex. 1 and 2 and Ex. 3 that when the air to be blown had a moisture content of 22 g/m³ or less, an ion exchange membrane having unevenness of the membrane thickness in the in-plane direction further suppressed was obtained.

It was confirmed from Ex. 2 and Ex. 4 that when the air to be blown had a linear velocity of 5.0 to 50.0 m/sec (more preferably 10.0 to 50.0 m/sec, further preferably 20.0 to 50.0 m/sec), an ion exchange membrane having unevenness of the membrane thickness in the in-plane direction further suppressed was obtained.

This application is a continuation of PCT Application No. PCT/JP2024/040957, filed on Nov. 19, 2024, which is based upon and claims the benefit of priority from Japanese Patent Application No. 2023-198375 filed on Nov. 22, 2023. The contents of those applications are incorporated herein by reference in their entireties.

What is claimed is:

1. A pellet production method, which comprises extruding a melt that contains a fluorinated polymer having groups convertible to ion exchange groups from a die of a melt-extruder to obtain a strand that contains the fluorinated polymer, and cutting the strand to obtain pellets that contain the fluorinated polymer,
wherein the method comprises an air-cooling treatment of cooling the strand extruded from the die by blowing air.

2. The pellet production method according to claim 1, wherein the groups convertible to ion exchange groups are groups convertible to carboxylic acid functional groups or groups convertible to sulfonic acid functional groups.

3. The pellet production method according to claim 1, wherein in the air-cooling treatment, the air to be blown has a moisture content of 22 g/m³ or less.

4. The pellet production method according to claim 1, wherein the air to be blown has a linear velocity of 5.0 to 50.0 m/sec.

5. The pellet production method according to claim 1, wherein the air to be blown has a temperature of 40° C. or lower.

6. The pellet production method according to claim 1, wherein the fluorinated polymer has an ion exchange capacity of 0.9 meq/g resin or more and 2.00 meq/g resin or less.

7. The pellet production method according to claim 1, wherein the pellets are used for production of an ion exchange membrane.

8. An ion exchange membrane production method, which comprises:
producing pellets by the pellet production method as defined in claim 1,
obtaining a precursor membrane using the pellets by melt-extrusion, and
obtaining an ion exchange membrane using the precursor membrane.

9. Pellets, which are produced by the method as defined in claim 1, and which have a hydrolysis rate of less than 1.00%.
